(19) United States
(12) Patent Application Publication
(10) Pub. No.: US 2025/0018542 A1
(43) Pub. Date: Jan. 16, 2025

(54) TOOL HAVING A CENTRAL TOOLHEAD

(71) Applicant: Don M. Spencer, JR., Owego, NY (US)

(72) Inventor: Don M. Spencer, JR., Owego, NY (US)

(21) Appl. No.: 18/904,131

(22) Filed: Oct. 2, 2024

Related U.S. Application Data
(63) Continuation of application No. 17/469,963, filed on Sep. 9, 2021, now Pat. No. 12,122,024.
(60) Provisional application No. 63/189,066, filed on May 15, 2021.

(51) Int. Cl. B25B 23/16; B25B 23/00; B25G 1/04

(52) U.S. Cl. CPC B25B 23/16; B25B 23/0007; B25G 1/043

(57) ABSTRACT

Tools are disclosed herein that in some examples include a handle consisting of first and second handle portions. The first and second handle portions include opposing first and second distal ends, respectively. Some of the exemplary tools further include a central toolhead disposed between the first and second handle portions. The central toolhead is in a same plane as the first and second handle portions and includes a first closed-ended wrench head. The exemplary tools disclosed herein exhibit improved leverage properties, among other advantages.

This application claims priority to U.S. patent application Ser. No. 17/469,963, filed Sep. 9, 2021, which claims priority to U.S. Provisional Application No. 63/189,066, filed May 15, 2021, the content of each of which is hereby incorporated by reference in its entirety.

### FIELD

This technology relates generally to the technical field of hardware tools, and more specifically to a tool having a central toolhead or wrench head disposed between first and second handle portions.

### BACKGROUND

The wrench is a commonly used installation and removal tool. It is a hand tool that uses the principle of leverage to turn bolts, screws, nuts, and other threads to hold the openings or sleeves of bolts or nuts using various types of wrench heads for connecting with those elements.

Traditionally, wrenches have been provided with a wrench head for securing to a bolt or nut element at either one or both ends of a straight handle portion. A user applies force at a distal end of the wrench to the wrench head connected to the nut or bolt element to rotate the bolt or nut in the direction of thread rotation.

A problem with this construction is that it often forces the user to position their body in such a way that only allows them to use one hand to effectively apply leveraged force to the nut or bolt element, limiting the amount of power applied. For bolts and nuts that are particularly difficult to turn due to rust, metal warping, and other issues, this can prevent users from using the full amount of strength required to turn and remove the element. Using both hands to apply force from an unstable position will cause the body to lose balance when exerting force, which can be a safety risk.

Similar problems exist with tools other than wrenches where leveraged force is applied across a handle portion. It is within this context that the present invention is provided.

### SUMMARY

The present disclosure provides a tool comprising a centrally placed tool head disposed between first and second handle portions which a user may grip with either hand in order to comfortable apply torque about the central toolhead from either side in a safe manner. The ability to effectively utilize force from both arms without losing balance facilitates a greater application of torque. The tool may be a wrench utilizing a central wrench head of any type but may also be another type of leverage-based tool such as a screwdriver or hammered tool.

Thus, according to one aspect of the present disclosure there is provided a tool having improved leverage properties, the tool comprising a first handle portion, a central tool head connected to the first handle portion, and a second handle portion connected to the central tool head, the first and second handle portions extending from the central tool head along a shared plane and at an angle of up to 180 degrees with respect to one another.

In some embodiments, the tool is a wrench, and the central toolhead is a wrench head.

The central toolhead may be slidably adjustable with respect to the first handle portion and/or the second handle portion.

The central toolhead may be rotationally adjustable with respect to the first handle portion and/or the second handle portion about an axis centered on the center toolhead and perpendicular to the shared plane of the handle portions such that the angle between the first handle portion and second handle portion can be changed.

The first handle portion and/or the second handle portion may be detachably connected to the central toolhead by an interchangeable connection.

The first handle portion may further comprise a second toolhead attached to the handle portion at the end distal from the connection to the central toolhead.

The second handle portion may further comprise a third toolhead attached to the handle portion at the end distal from the connection to the central toolhead.

The central toolhead may protrude outwardly from a central base portion.

The wrench head may be one of the following types: a pipe wrench head, chain wrench head, socket wrench head, torque wrench head, ratcheting wrench head, oil filter wrench head, combination wrench head, open-ended wrench head, closed-ended wrench head, crowfoot wrench head, pedal wrench head, monkey wrench head, pliers wrench head, strap wrench head, plumber's wrench head, tap wrench head, spud wrench head, alligator wrench head, basin wrench head, armorer's wrench head, dog bone wrench head, drum key wrench head, bung wrench head, fan clutch wrench head, hammer wrench head, torx key wrench head, cone wrench head, garbage disposal wrench head, tension wrench head, spoke wrench head, spanner wrench head, nut driver wrench head, box end wrench head, flare nut wrench head, allen wrench head, bristol wrench head, ratcheting box wrench head, flex wrench head, socket ratchet wrench head, lug wrench head, and spark plug wrench head.

Furthermore, the first handle portion may further comprise a second wrench head attached to the handle portion at the end distal from the connection to the central toolhead, the second wrench head also being selected from the listed types.

Additionally or alternatively, the second handle portion may further comprise a third wrench head attached to the handle portion at the end distal from the connection to the central toolhead, the second wrench head also being selected from the listed types.

The wrench head may have one of the following drive geometry types: flank drive, spline drive, 10-pointed drive, 12-pointed drive.

The wrench as a whole may be one of the following types: pipe wrench, chain wrench, socket wrench, torque wrench, ratcheting wrench, oil filter wrench, combination wrench, adjustable wrench, impact wrench, crowfoot wrench, pedal wrench, monkey wrench, pliers wrench, strap wrench, plumber's wrench, tap wrench, spud wrench, alligator wrench, basin wrench, armorer's wrench, dog bone wrench, drum key, bung wrench, fan clutch wrench, hammer wrench, torx key, cone wrench, garbage disposal wrench, tension wrench, spoke wrench, spanner wrench, nut driver wrench, box end wrench, flare nut wrench, allen wrench, bristol wrench, ratcheting box wrench, flex wrench, socket ratchet wrench, lug wrench, and spark plug wrench.

### BRIEF DESCRIPTION OF THE DRAWINGS

Various embodiments of the invention are disclosed in the following detailed description and accompanying drawings.

FIG. 1 illustrates an isometric view of an example configuration of a tool according to the present disclosure in the form of a wrench having a closed-ended wrench head disposed between an open-ended wrench head and a second closed-ended wrench head.

FIG. 2 illustrates a second isometric view of the example configuration of the tool of FIG. 1.

FIG. 3 illustrates an isometric top-down view of the example configuration of the tool of FIG. 1.

FIGS. 4A-C illustrate isometrics view of other example configurations of a tool according to the present disclosure in the form of a wrench having an open-ended wrench head disposed between first and second handle portions at a 45 degree angle to one another, a wrench with a central open-ended wrench head disposed between first and second handle portions, and a wrench with central, open-ended, detachable, and interchangeable wrench heads disposed between first and second handle portions, respectively.

FIGS. 5A-C illustrate isometric views of other example configurations of a tool according to the present disclosure in the form of a wrench having a closed-ended wrench head disposed between first and second handle portions at a 45 degree angle to one another, a wrench with a central closed wrench head disposed between first and second handle portions, and a wrench with central, closed, detachable, and interchangeable wrench heads disposed between first and second handle portions, respectively.

FIG. 6 illustrates an isometric view of another example configuration of a tool according to the present disclosure in the form of a wrench having a central open-ended wrench head extending from the joint of the two handle portions.

FIG. 7 illustrates an isometric view of another example configuration of a tool according to the present disclosure in the form of a wrench having an adjustable open-ended wrench head disposed between first and second handle portions at a 45 degree angle to one another.

FIG. 8 illustrates an isometric view of another example configuration of a tool according to the present disclosure in the form of a wrench having an adjustable open-ended wrench head disposed between first and second handle portions which are adjustable connected so as to be able to change the angle between them, shown in a closed position.

FIG. 9 illustrates an isometric view of another example configuration of a tool according to the present disclosure in the form of a wrench having an adjustable open-ended wrench head disposed between first and second handle portions which are adjustable connected so as to be able to change the angle between them, shown in a partially open position.

FIG. 10 illustrates an isometric view of another example configuration of a tool according to the present disclosure in the form of a wrench having an adjustable open-ended wrench head disposed between first and second handle portions which are adjustable connected so as to be able to change the angle between them, shown in a closed position.

FIG. 11 illustrates an isometric view of another example configuration of a tool according to the present disclosure having a similar configuration to that of FIGS. 1-3, but with the central wrench head protruding perpendicularly to the plan of the handle portions so as to provide space for a user's fingers.

FIGS. 12A-B illustrate isometric views of other example configurations of a tool according to the present disclosure in the form of a wrench with a fixed, central, socket head disposed between first and second handle portions, a wrench with detachable, interchangeable, and central socket heads disposed between first and second handle portions, respectively.

FIG. 13 illustrates an isometric view of a lug wrench with first and second handle portions applied to a lug nut on the wheel of a vehicle.

FIG. 14 illustrates an isometric view of another example configuration of a tool according to the present disclosure having a pipe wrench head disposed between first and second handle portions.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present disclosure provides a tool which enables the user to tighten and loosen a fastener, nut or bolt from a central point where a toolhead rests between two handle portions, for example the center of the wrench shaft, while holding the ends of the handle portions with both hands for more power and leverage during turning.

The tool does not necessarily have to be a wrench and could also be implemented as a screwdriver or hammered tool. If the tool is a wrench, any combination of different wrench heads may be used between the central toolhead and toolheads on the opposing ends of the handle portions, including having no toolheads on the opposing ends of the handle portions.

Various example configurations are illustrated and described that are meant solely as illustrative examples and are not limiting. Other configurations and modifications not explicitly described herein could also be included in conjunction with the tool of the present disclosure as described and illustrated by way of the examples herein.

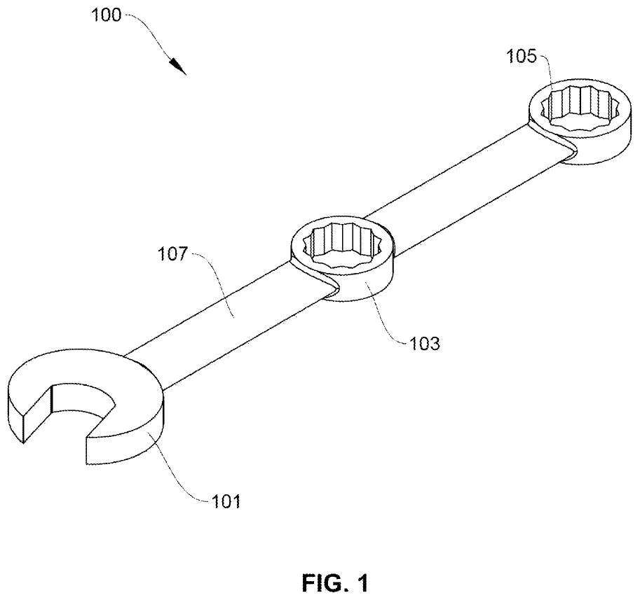

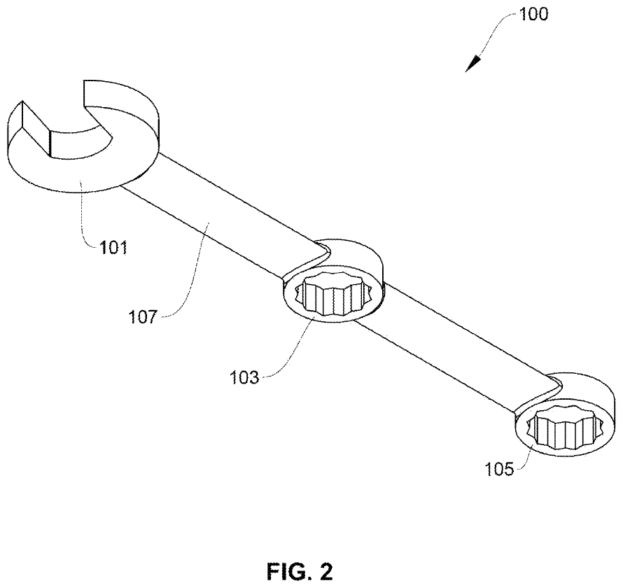

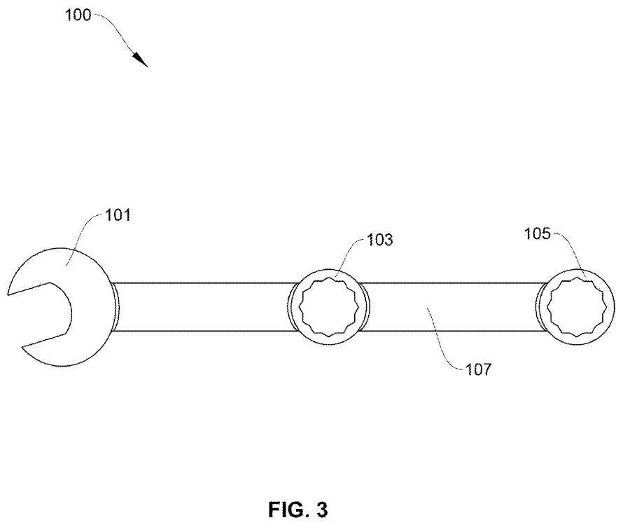

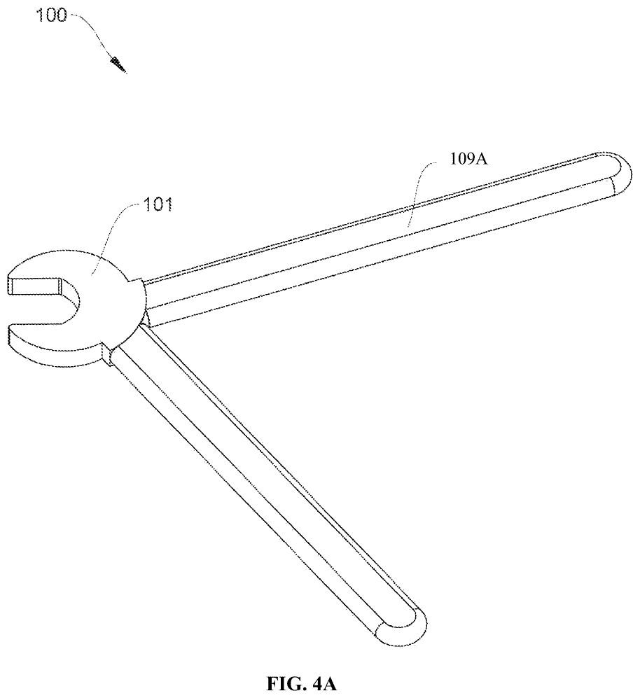

Referring to FIGS. 1-3, various views of an example configuration of a wrench 100 according to the present disclosure are shown.

In the illustrated configuration, the wrench has a closed-ended wrench head 103 disposed at the center between two handle portions 107, and with an open-ended wrench head 101 and a second closed-ended wrench head 105 at the opposing distal ends of the wrench.

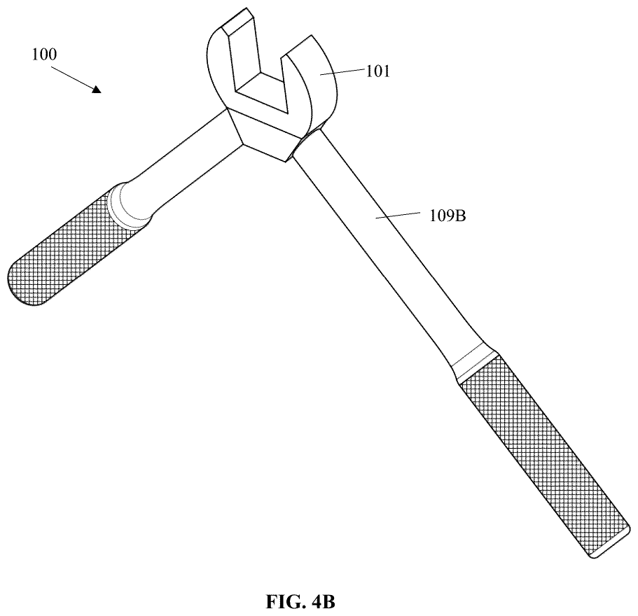

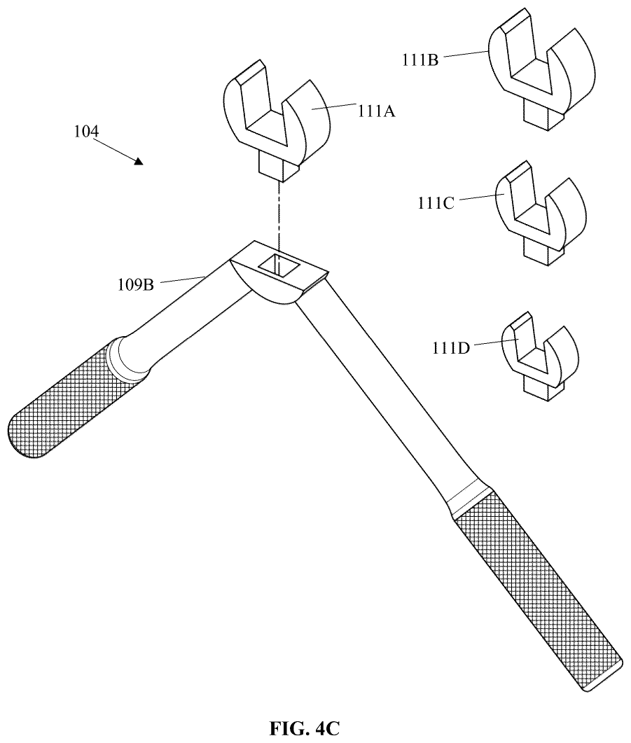

An alternative configuration of the disclosed wrench 100 is shown in FIGS. 4A-C. Referring more specifically to FIG. 4A, the wrench 100 has an open-ended wrench head 101 disposed between first and second handle portions 109A, which are at a 60 degree angle to one another. The first and second handle portions 109A are generally formed of one piece of material. In FIG. 4B, the wrench 100 is illustrated with the open-ended wrench head 101 positioned on top of V-shaped first and second handle portions 109B. In FIG. 4C, another wrench 104 is illustrated with central, open-ended, detachable, and interchangeable wrench heads 111A-D configured to be positioned on top of the V-shaped first and second handle portions 109B and having variant sizes.

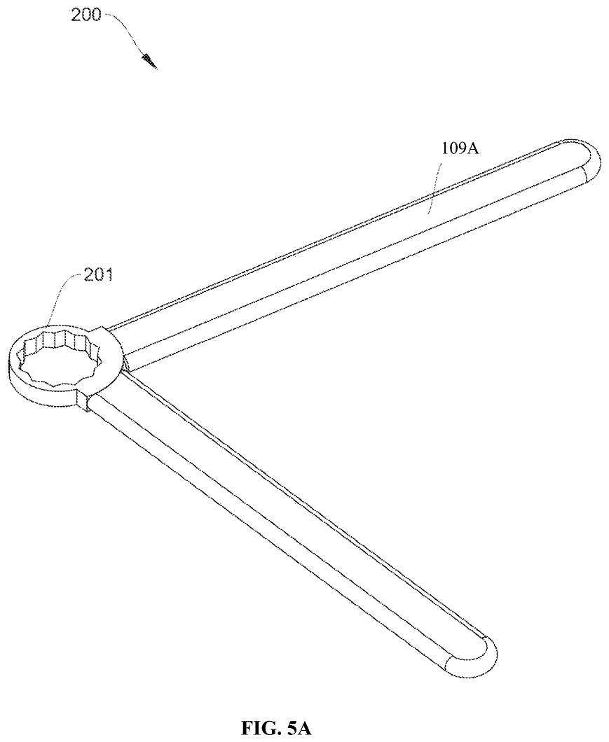

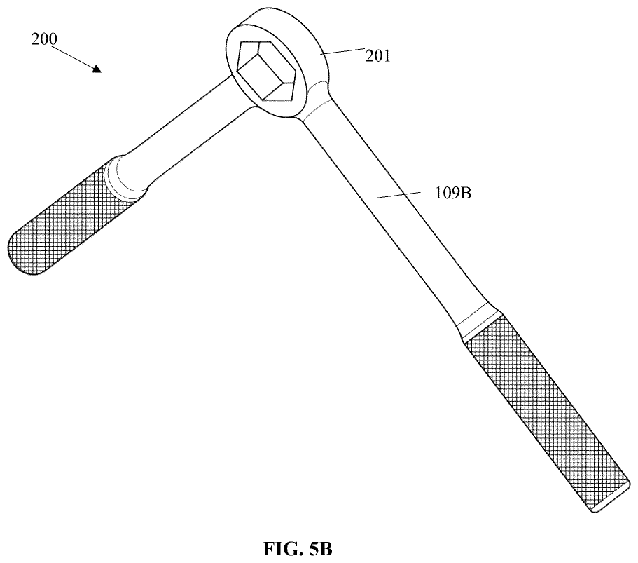

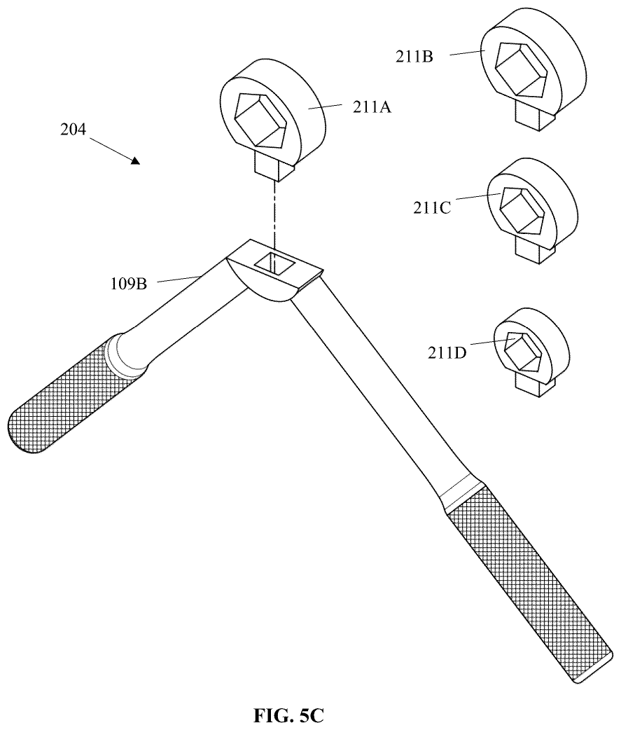

FIGS. 5A-C show similar configurations to FIGS. 4A-C, respectively, but the wrench 200 comprises a closed-ended wrench head 201 as the central toolhead disposed between the two handle portions 109A. In FIG. 5B, the wrench 200 is illustrated with the closed wrench head 201 positioned on top of V-shaped first and second handle portions 109B. In FIG. 5C, another wrench 204 is illustrated with central, closed, detachable, and interchangeable wrench heads 211A-D configured to be positioned on top of the V-shaped first and second handle portions 109B and having variant sizes.

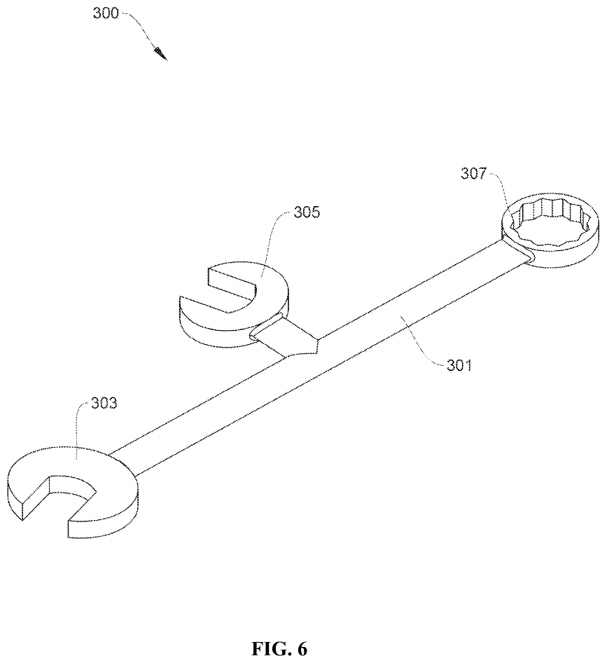

Referring to FIG. 6 another alternative example configuration is shown with a wrench 300 having a central open-ended wrench head 305 extending from the joint of the two handle portions 301.

An open-ended wrench head 303 and a closed-ended wrench head 307 are disposed at either end of the straight handle portions 301.

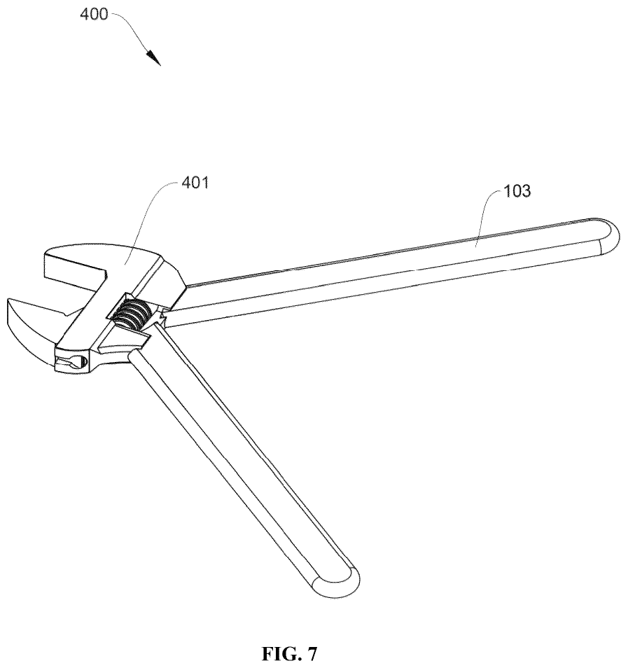

As shown in FIG. 7, the tool can also comprise a wrench 400 with an adjustable open-ended central wrench head 401 disposed between the two handle 103.

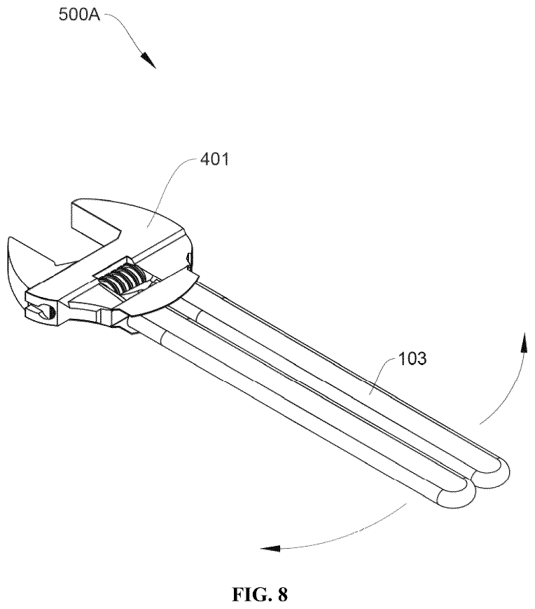

Furthermore, in some configurations, the handle portions 103 themselves may be adjustable as shown in FIGS. 8-10 where another example configuration is shown in the form of a wrench 500 having an adjustable open-ended wrench head 401 disposed between first and second handle portions 103, but with the handle portions 103 being rotatably adjustable so as to be able to change the angle between them like a pair of scissors.

In this configuration, the first and second handle portions are joined together by a flexible joint.

Referring to FIG. 8, the configuration of FIGS. 8-10 may have the handle portions completely together in position 500A. The handle portions then effectively act as a single wider handle.

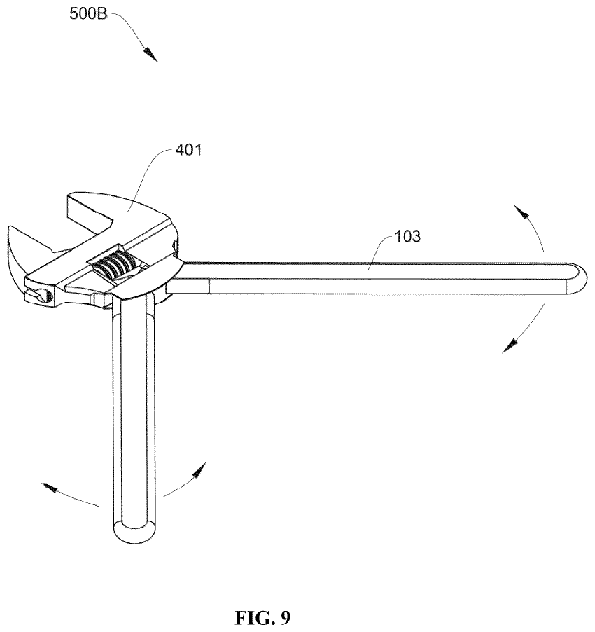

Referring to FIG. 9, the configuration of FIGS. 8-10 may have the handle portions partially open in position 500B or any angle between 0 and 180 degrees. This flexibility can be very useful when working in tight spaces.

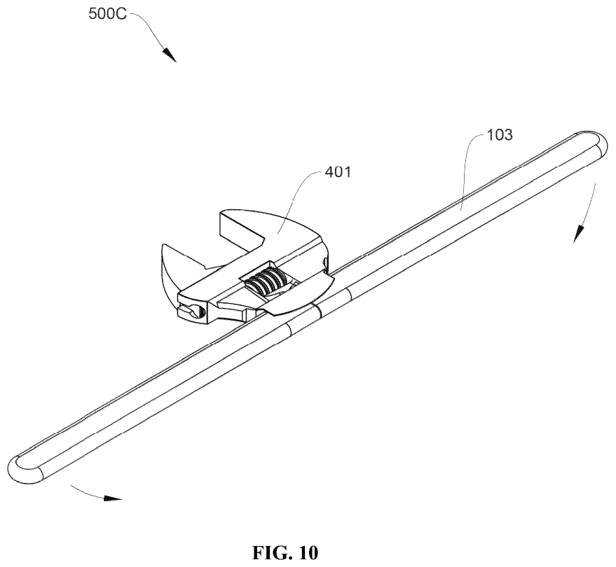

Referring to FIG. 10, the configuration of FIGS. 8-10 may have the handle portions completely apart as in position 500C to form a long handle shaft with the wrench head 401 at the center. This allows for maximum torque to be applied.

Although not illustrated, the central toolhead may also be slidable along the handle portions to bias it away from the center of the wrench shaft, the handle portions may be detachable from the central toolhead so that different handle portions appropriate for the job at hand can be interchangeably affixed to the tool, and the handle portions may even be retractable to provide increased versatility.

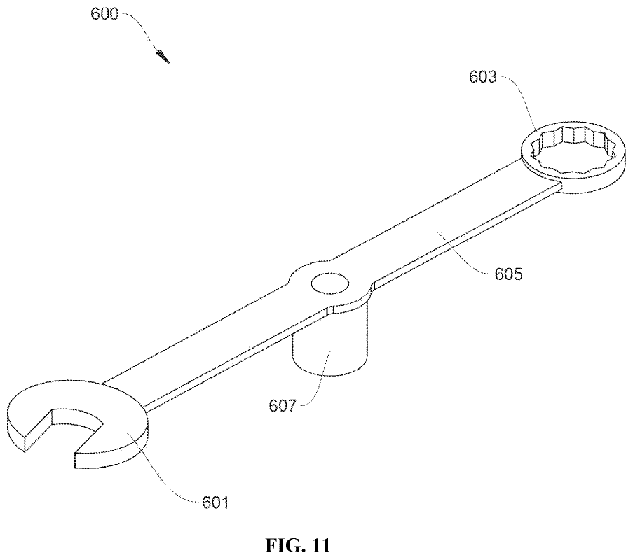

Referring to FIG. 11, another example configuration of a wrench 600 having a similar configuration to that of FIGS. 1-3 is shown, with an open ended wrench head 601 and a closed ended wrench head 603 disposed at either end of the handle portions which from a straight shaft, but also with the central wrench head 607 protruding perpendicularly to the plane of the handle portions similarly to a nut driver wrench head so that when the central wrench head is placed on a nut, the wrench will be raised or elevated so the user will have room to fit his fingers underneath the wrench when he holds it with both hands. Otherwise, the wrench might lay flush on a base surface that the fastener is located on, preventing a user from properly gripping the handle portions.

The wrench head, both the central head and the head at either end of the handle portions, can be any one of the following non-exhaustive list: a pipe wrench head, chain wrench head, socket wrench head, torque wrench head, ratcheting wrench head, oil filter wrench head, combination wrench head, open-ended wrench head, closed-ended wrench head, crowfoot wrench head, pedal wrench head, monkey wrench head, pliers wrench head, strap wrench head, plumber's wrench head, tap wrench head, spud wrench head, alligator wrench head, basin wrench head, armorer's wrench head, dog bone wrench head, drum key wrench head, bung wrench head, fan clutch wrench head, hammer wrench head, torx key wrench head, cone wrench head, garbage disposal wrench head, tension wrench head, spoke wrench head, spanner wrench head, nut driver wrench head, box end wrench head, flare nut wrench head, allen wrench head, bristol wrench head, ratcheting box wrench head, flex wrench head, socket ratchet wrench head, lug wrench head, and spark plug wrench head.

If the wrench head is a socket head type, it can have 12 any socket geometry, including but not limited to: flank drive, spline drive, 10-pointed drive, 12-pointed drive.

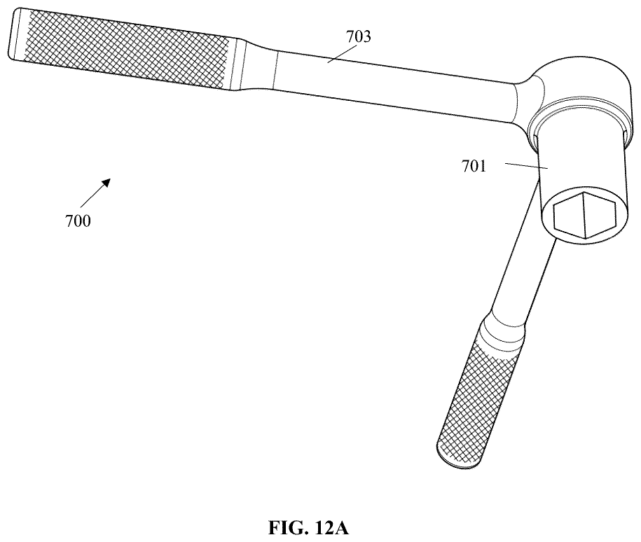

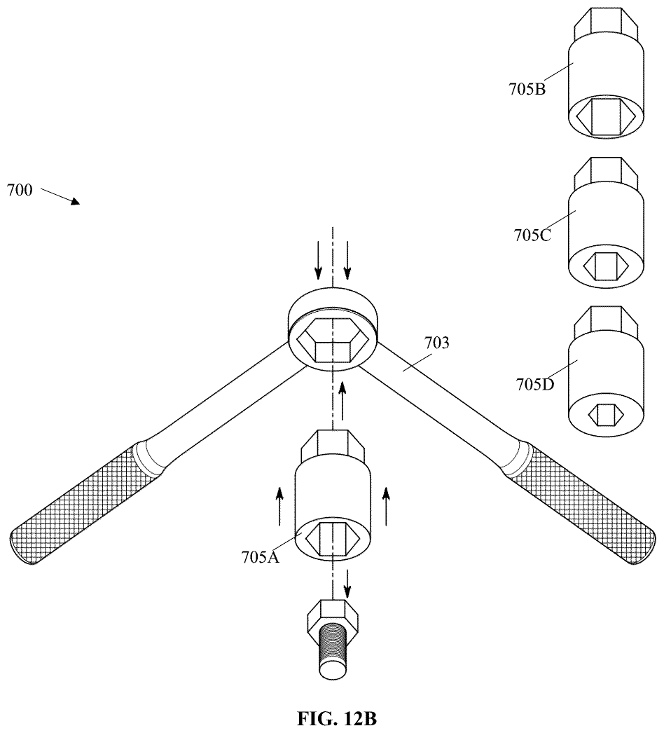

Referring now to FIGS. 12A-B, isometric views of other example configurations of a tool according to the present disclosure are illustrated in the form of, with respect to FIG. 12A, a wrench 700 with a fixed, central, socket head 701 disposed between first and second V-shaped handle portions 703. In FIG. 12B, the wrench 700 is illustrated with detachable, interchangeable, and central socket heads 705A-D positioned on the V-shaped first and second handle portions 703 with interchangeable connectivity and an array of socket sizes.

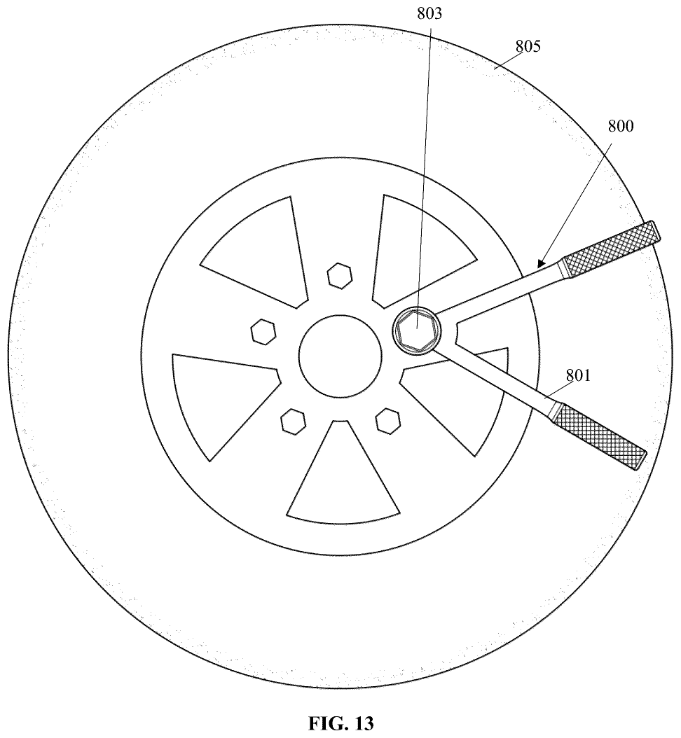

FIG. 13 illustrates an isometric view of a lug wrench 800 with V-shaped first and second handle portions 801 applied to a lug nut 803 on the wheel 805 of a vehicle (not shown).

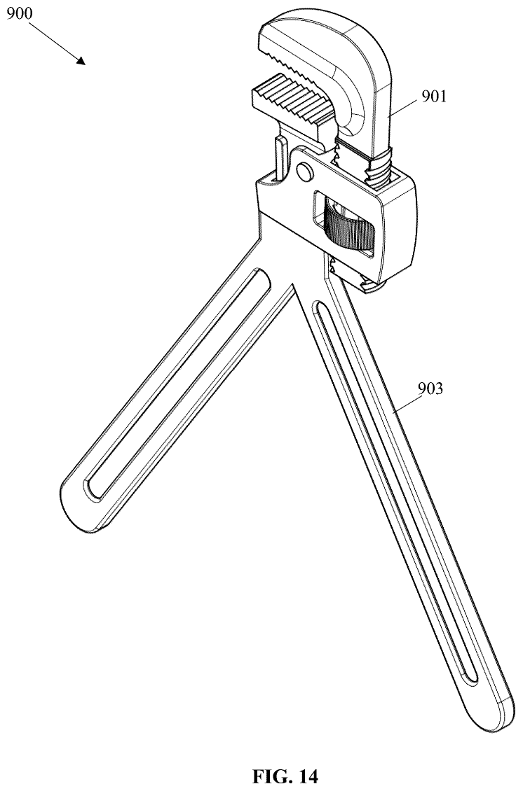

FIG. 14 illustrates an isometric view of another example configuration of a tool 900 according to the present disclosure having a pipe wrench head 901 positioned on top of V-shaped first and second handle portions 903.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the tool having a central toolhead have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described arc merely illustrative of the application of the principles of the invention. Reference herein to details of the illustrated embodiments is not intended to limit the scope of the claims, which themselves recite those features regarded as essential to the invention.

1. A tool, comprising:
a shaft consisting of first and second handle portions, wherein the first and second handle portions comprise opposing first and second distal ends, respectively; and
a central toolhead disposed between the first and second handle portions, wherein the central toolhead is in a same plane as the first and second handle portions and comprises a first closed-ended wrench head.

2. The tool of claim 1, wherein one or more of the first distal end comprises a first toolhead or the second distal end comprises a second toolhead.

3. The tool of claim 2, wherein the one or more of the first toolhead or the second toolhead comprises an open-ended wrench head or a second closed-ended wrench head.

4. The tool of claim 2, wherein one or more of the first toolhead, the second toolhead, or the central toolhead comprises a ratcheting wrench head.

5. The tool of claim 2, wherein at least one of the first toolhead or the second toolhead is detachable from the first handle portion or the second handle portion, respectively.

6. The tool of claim 1, wherein the central toolhead is position adjustable with respect to one or both of the first handle portion or the second handle portion.

7. A tool, comprising:
first and second handle portions comprising opposing first and second distal ends, respectively, wherein at least the first distal end comprises a first toolhead operable in a shared plane of the first and second handle portions; and
a central toolhead extending from a first connection between the first and second handle portions, perpendicular to a long axis of the first and second handle portions, and operable in the shared plane.

8. The tool of claim 7, wherein the second distal end comprises a second toolhead operable in the shared plane.

9. The tool of claim 8, wherein one or more of the first toolhead, the second toolhead, or the central toolhead comprises an open-ended wrench head or a closed-ended wrench head.

10. The tool of claim 8, wherein one or more of the first toolhead, the second toolhead, or the central toolhead comprises a ratcheting wrench head.

11. The tool of claim 8, wherein at least one of the first toolhead, the second toolhead, or the central toolhead is detachable from the first handle portion, the second handle portion, or the first connection, respectively.

12. The tool of claim 7, wherein the central toolhead is position adjustable with respect to one or both of the first handle portion or the second handle portion.

13. The tool of claim 7, wherein the first handle portion and the second handle portion comprise a straight monolithic shaft from which the central toolhead extends.

14. A tool, comprising:
a shaft consisting of first and second handle portions, wherein the first and second handle portions comprise opposing first and second distal ends, respectively, and are disposed in a shared plane; and
a central toolhead extending from a connection between the first and second handle portions and perpendicular to a long axis of the first and second handle portions, wherein the central toolhead is operable in another plane parallel to the shared plane.

15. The tool of claim 14, further comprising a central base portion disposed proximate the connection, wherein the central toolhead protrudes outwardly from the central base portion and the first handle portion, the second handle portion, and the shaft is straight and monolithic.

16. The tool of claim 14, wherein one or more of the first distal end comprises a first toolhead operable in the shared or the second distal end comprises a second toolhead operable in the shared plane.

17. The tool of claim 16, wherein at least one of the first toolhead, the second toolhead, or the central toolhead is detachable from the first handle portion, the second handle portion, or the connection, respectively.

18. The tool of claim 16, wherein one or more of the first toolhead, the second toolhead, or the central toolhead comprises a pipe wrench head, chain wrench head, socket wrench head, torque wrench head, oil filter wrench head, combination wrench head, open-ended wrench head, closed-ended wrench head, crowfoot wrench head, pedal wrench head, monkey wrench head, pliers wrench head, strap wrench head, plumber's wrench head, tap wrench head, spud wrench head, alligator wrench head, basin wrench head, armorer's wrench head, dog bone wrench head, drum key wrench head, bung wrench head, fan clutch wrench head, hammer wrench head, torx key wrench head, cone wrench head, garbage disposal wrench head, tension wrench head, spoke wrench head, spanner wrench head, nut driver wrench head, box end wrench head, flare nut wrench head, allen wrench head, bristol wrench head, ratcheting box wrench head, flex wrench head, socket ratchet wrench head, lug wrench head, or spark plug wrench head.

19. The tool of claim 16, wherein one or more of the first toolhead, the second toolhead, or the central toolhead comprises a drive geometry types selected from a flank drive, a spline drive, a 10-pointed drive, a 12-pointed drive, or a 6-pointed drive.

20. The tool of claim 16, wherein one or more of the first toolhead, the second toolhead, or the central toolhead comprises a ratcheting wrench head.

21. The tool of claim 1, wherein the central toolhead further comprises a ratcheting wrench head.

22. The tool of claim 14, wherein the central toolhead is detachable from the connection.
